(19) United States
(12) Patent Application Publication
(10) Pub. No.: US 2005/0141509 A1
(43) Pub. Date: Jun. 30, 2005

(54) Ethernet to ATM interworking with multiple quality of service levels

(76) Inventors: Sameh Rabie, Kanata (CA); John Whatman, Ottawa (CA); Richard Pommainville, Ottawa (CA); Bashar Abdullah, Ottawa (CA); Baghdad Barka, Nepean (CA); John Rosser Davies, Kanata (CA)

Correspondence Address: NORTEL NETWORKS LIMITED, P. O. BOX 3511, STATION C, OTTAWA, ON, K1Y 4H7, CA

(21) Appl. No.: 10/744,001

(22) Filed: Dec. 24, 2003

(51) Int. Cl. H04L 12/28

(52) U.S. Cl. 370/395.1; 370/395.21

(57) ABSTRACT

A method of supporting multiple quality of service (QoS) levels for data being transmitted between two networking devices, such as customer equipment (CE), that use Ethernet and Asynchronous Transfer Mode (ATM). The method supports multiple QoS services in a network where a first CE is connected to a first edge device (interworking unit) using the Ethernet protocol and a second CE is connected to a second edge device using the ATM protocol. The edge devices may be directly connected together or they may be connected through a network backbone using any generally accepted network protocol. The first CE may be connected to the first edge device using a single Ethernet port, multiple Ethernet ports, a single virtual local area network (VLAN), or multiple VLAN's. The second CE is connected to an edge device using a single virtual circuit connection (VCC), a single virtual path connection (VPC), or multiple VCC's. The method ensures QoS for data transmitted between the first and the second CE via the Ethernet protocol to the ATM protocol and vice versa.

### FIELD OF THE INVENTION

The present invention relates to methods of supporting multiple quality of service (QoS) levels for packets being transmitted over Ethernet and Asynchronous Transfer Mode (ATM) networks.

### BACKGROUND OF THE INVENTION

Service providers are committed to providing the type of connectivity their customers require. As a result, the presence of Frame Relay (FR), Asynchronous Transfer Mode (ATM), or Point-to-Point (PPP) technologies on the customer side of the network is not uncommon. These feeds usually connect to a multi-service switch/router.

Ethernet is increasingly being used to interconnect customer equipment through provider networks. The high-speed uplink, however, is often ATM, Packet over Synchronous Optical Network (POS), or Gigabit Ethernet. This demand for various types of connectivity creates many challenges. A primary challenge is mapping the data correctly from one type of technology to another without traffic loss or data-integrity problems. Another challenge involves meeting service guarantees to the customer to meet the applications' requirements.

The legacy Ethernet Standard and devices support only a single QoS per interface. Similarly ATM Standards do not support multiple QoS levels per connection.

The Institute of Electrical and Electronics Engineers (IEEE) Standard 802.1Q Ethernet Specification, however defines a tag, inserted into Ethernet frames, that defines virtual-LAN (VLAN) membership. Three bits in this tag identify user priority as defined by IEEE 802.1Q to provide for up to eight priority levels. Switches and routers can, therefore, use the tag to give traffic precedence by queuing outgoing frames in multiple buffers.

Similarly, Diff-Serv is an Internet Engineering Task Force (IETF) specification that works at the network layer by altering the Internet protocol (IP) type-of-service field to identify particular classes of service, The Internet Engineering Task Force (IETF) is a large open international community of network designers, operators, vendors, and researchers concerned with the evolution of the Internet architecture and the smooth operation of the Internet. Diff-Serv could be used for signaling the class of service per Ethernet frame when the Upper Layer Protocol (ULP) is IP. Diff-Serv, however, is simply a class-of-service management scheme rather than a complete QoS mechanism.

Other internetworking protocols available for supporting QoS include: Resource Reservation Protocol Traffic Engineering (RSVP-TE), used to reserve end-to-end network resources for a particular network flow (in one direction); Real-Time Transport Protocol, which is optimized to deliver real-time data such as audio and video streams through multiplexed User Datagram Protocol (UDP) links; IP Multicast; and Multi-protocol Label Switching (MPLS).

The Metro Ethernet Forum (MEF) stipulates the use of the IEEE 802.1Q tag and/or the layer 3 (L3), and higher layer, fields in the packet header to support multiple QoS on an Ethernet interface. The most common application among networking providers is when L3 traffic is IP with Diff-Serv.

By compassion, in ATM networking, both the transport layer as well as the ATM-network-layer must be in the agreement to enable the required QoS support. The agreement between two or more users has two major parts. The first one a traffic descriptor. It characterizes the load to be offered, and typically includes the peak cell rate (PCR), sustained cell rate (SCR), Maximum Burst Size (MBS), and minimum cell rate (MCR), depending on the ATM service class. The second part specifies the QoS desired by the customer and accepted by the carrier. The ATM standard defines QoS parameters whose values the customers can negotiate. Typically, each parameter is defined by the worst-case performance that the carrier is required to meet or exceed it. For example, cell loss ratio (CLR), maximum transfer delay, and cell delay variation. The ATM Standards describe methods for signaling or configuring QoS per connection. However, they do not allow supporting multiple QoS levels per connection.

### SUMMARY OF THE INVENTION

The present invention describes methods and systems for Ethernet to ATM Interworking with Multiple Quality of Service Levels.

In accordance with a broad aspect of the invention there is provided a method for enabling multiple QoS support of Asynchronous Transfer Mode (ATM) and Ethernet networks comprising: identifying a packet according to a first network protocol for servicing; determining a QoS metric for the identified packet; and based upon the determine QoS metric, servicing the identified packet for transmission in accordance with a second network protocol.

In accordance with another broad aspect of the invention there is provided a system for enabling multiple QoS support over ATM and Ethernet networks comprising: an input; and control circuitry associated with the input and adapted to: identify a packet according to a first network protocol for servicing; determine a QoS metric for the identified packet; and based upon the determined QoS metric, service the identified packet for transmission in accordance with a second network protocol.

In accordance with one embodiment of the invention the system referred to above is located at an edge of a core network. In accordance with another embodiment of the invention the system referred to above is located in a user element.

In accordance with a broad embodiment of the invention there is provided an Interworking Unit (IWU) interfaced between an Ethernet and ATM network. Based upon this Ethernet-IWU-ATM configuration, several combinations are presented within the same general scope of the present invention. According to particular embodiments of the invention there are provided several methods for supporting multiple QoS levels between Ethernet-based and ATM-based customer equipment (CE).

Embodiments of the invention provide methods for supporting multiple QoS services in a network where a first CE is connected to a first IWU using the Ethernet protocol and a second CE is connected to a second IWU using the ATM protocol. The IWUs may be directly connected together or connected through a network backbone using any number of network protocols. The first CE may be connected to the first IWU using a single Ethernet port, multiple Ethernet ports, a single virtual local area network (VLAN), or multiple VLAN's. The Ethernet port may be legacy/untagged where all incoming traffic would receive the same QoS treatment, or tagged supporting the IEEE 802.1Q Standard. Tagged interfaces may use the VLAN ID and/or the p-bits for indicating implicitly or explicitly the QoS of the frame. The second CE may be connected to an edge device using a single virtual circuit connection (VCC), a single Virtual Path Connection (VPC), or multiple VCCs. The CE's may also be bridged at layer 2 or routed at layer 3 IP. The IWUs enable multiple QoS support on the network access link in the egress direction (network edge to CE direction).

The present inventions support multiple QoS, while maintaining operations simplicity, bandwidth sharing, segregation among traffic classes, scalability, and support of tagged and untagged interfaces.

The present invention may further enable ordered delivery of frames between CE devices by ensuring that traffic classified with the same QoS is delivered to the terminating CE device in the order that it was transmitted from the originating CE device.

### BRIEF DESCRIPTION OF THE DRAWINGS

FIGS. 1A and 1B are schematics diagrams of the present invention in accordance with broad embodiments thereof.

FIG. 2 is a schematic of a communication system according to a first embodiment of the invention.

FIG. 3 is a schematic of a communication system according to a second embodiment of the invention.

FIG. 4 is a schematic of a communication system according to a third embodiment of the invention.

FIG. 5 is a schematic of a communication system according to a fourth embodiment of the invention.

FIG. 6 is a flow diagram according to embodiments of the present invention.

### DETAILED DESCRIPTION OF THE PREFERRED EMBODIMENTS

The invention will be described for purposes of illustration only in connection with certain embodiments. However, it is to be understood that other objects and advantages of the present invention will be made apparent by the following description of the drawings according to the present invention. While preferred embodiments are disclosed, this is not intended to be limiting. Rather, the general principles set forth herein are considered to be merely illustrative of the scope of the present invention and it is to be further understood that numerous changes may be made without straying from the scope of the present invention.

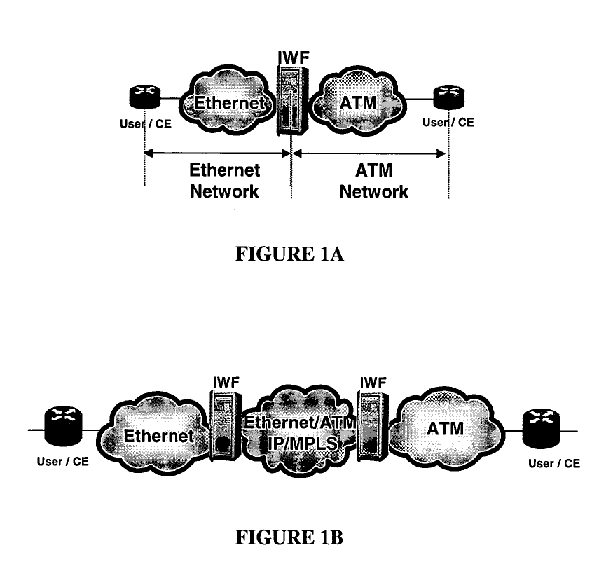

FIG. 1A is a schematic of an Ethernet/ATM communications system according to an embodiment of the invention. Specifically, there is shown a gateway solution having a direct interworking unit (IWU), disposed between an Ethernet and ATM network.

Similarly FIG. 1B presents a schematic of an Ethernet/ATM communication system according to another broad embodiment of the invention wherein IWUs are disposed on either edges of a core network, which core network may include Ethernet, ATM, IP, MPLS or any other such core network as is well known in the art.

While the following description focuses on the access QoS between the customer equipment (CEs) and their respective networks, as congestion often occurs here due to the relatively narrow bandwidth ‘pinch-point’ in the first/last mile, one skilled in the art will appreciate that the following techniques can be equally extended to the core network. Similarly, one skilled in the art will appreciate that, although, the following description refers to processing which occurs in an IWU, said processing could occur in the CE, which may include customer-located equipment as in carrier-managed services, internal networking devices such as voice or wireless servers/gateways, or external interworking devices for connecting different networks/service providers.

One of skill in the art will also appreciate that while separate ATM and Ethernet IWUs are described in the following examples, one could utilize a single IWU by extending the attachment circuit (AC) (Ethernet or ATM) to the other network edge.

To enable multiple QoS support for packets traversing Ethernet and ATM networks, the respective IWUs perform different functions as ATM and Ethernet networks have different roles and QoS capabilities. For example, in practice an ATM VCC may carry multiple VLANs, but the reverse is less likely. Conversely, a tagged Ethernet frame can carry QoS indications (p-bits), but typically not an ATM cell that can only carry discard priority information.

As will be apparent to one skilled in the art, enabling multiple QoS support in accordance with the techniques described below may incorporate several additional techniques known in the art such as queuing, scheduling, policing, shaping, routing, admission control, and congestion control. An example of a scheduling technique is egress link scheduling. In accordance with an embodiment of the present invention each service/traffic class is serviced in its own class queue by a class-based scheduler. Such scheduler would normally favor the premium classes over the lower-priority classes. Within each class queue, each packet can be assigned a different drop precedence where higher drop precedence packets are discarded before lower-precedence ones under congestion.

Generally speaking, the IWU to ATM side QoS may be determined based on the Ethernet port information, VLAN, p-bits, VLAN and p-bits, or upper layer protocol information (L3-L7) including Differentiated Services Code Point (DSCP) information, IP, IPX, SNA, TPC, UDP, and application information:
A) Using Ethernet information—This is the typical case, when either the QoS information is carried within the frame or configured per Ethernet port. For example, the QoS may be determined based on port/p-bits, port/VLAN, or port/VLAN/p-bits. MAC addresses may also be used, which can play a similar role to VLANs in identifying connections/QoS; or
B) Using ULP information—For example DSCP or L3-L7 information including, protocol types, IP source/destination addresses, TCP/UDP port numbers and application types.

The packet is then serviced for transmission on the IWU to ATM side, thereby enabling multiple QoS support, using one of the following techniques:
A) Using multiple VCCs with one VCC per QoS. In this instance a packet may be mapped to one of the VCC's and scheduled according to a connection scheduling scheme to deliver the QoS differentiation among the VCCs. As will be apparent to one skilled in the art two or more QoS levels could be combined in one VCC for economy;
B) Using a Virtual Path Connection (VPC). In this scenario, multiple VCCs may be mapped (multiplexed) onto a single virtual path connection (VPC). In this instance a packet would be mapped to the VPC/VCC and scheduled according to a sub-connection scheduling scheme for offering different treatment to the VCCs within the VPC; or
C) Using a single VCC. In this scenario, the packet may be mapped to a single VCC, and then scheduled for transmission according to a sub-connection scheduler that can schedule multiple queues within a single VCC. The sub-connection scheduler in this instance being further capable of scheduling multiple queues in a single VCC without interleaving. Such a scheduler must be able to schedule complete frames (e.g., ML 5 frames) from each queue (not ATM cells as used in conventional ATM), in order to enable the correct reassembly of the frames at the receiving end.

In the IWU to ATM scenario, the ATM interface can support a combination of legacy ATM Virtual Circuits (VC) Ethernet-Aware Virtual Circuit Connections (VCC), and IP-Aware VCCs simultaneously. The use of an ATM VCC for carrying multiple QoS frames provides a scalable solution. However, an ATM Virtual Path can also be used instead of the ATM VCC in any of the embodiments presented. In this case, each QoS flow would be assigned a separate VCC within the common/parent VPC. This scheme is beneficial in cases, for example, where the associated scheduler does not support frame interleaving.

For purposes of the foregoing general examples, the various scheduling schemes described above refer to discrete levels of a hierarchical scheduling scheme, which may include the following levels:
a. A Class Scheduler, for allocating link bandwidth among the various standard ATM services. Typically, a class-based scheduler is used for favoring the important classes.
b. A Connection Scheduler, for managing bandwidth among the various ATM VCCs, and VPCs. Typically, a Weighted Fair Queuing (WFQ) or class-based queuing scheduler is used for this purpose. Some of these connections may be legacy L2 ATM, while others may be Ethernet (or IP)-aware with multiple QoS.
c. Sub-connection Scheduler—These later VCCs will use another class-based scheduling level for allocating the VCC bandwidth among its various traffic classes based on the p-bits (or IP DSCP). This scheduling level may also enforce frame interleaving if necessary (e.g., at AAL5 frame boundary) as opposed to cell interleaving, to prevent frames scramble and allow assembly at the end point.

Similarly, the IWU to Ethernet side QoS is determined based on either the Ethernet/Upper layer Protocol (ULP) info as described above with respect to the IWU to ATM side determination, or ATM information:
A) Using ATM information—For example, the VCC ID, when multiple VCCs are used, or CLP information. This option may be used if the native service is not Ethernet (for example when interworking PPP/ATM to PPP/Ethernet, or when the Ethernet frames do not carry QoS indications.

The packet is then serviced for transmission on the IWU to Ethernet side, thereby enabling multiple QoS support, using one of the following techniques:
A) Using multiple Ethernet ports. In this instance a packet may be mapped to one of the Ethernet ports that supports its QoS. The port need not implement a sophisticated scheduler when a single QoS is supported per port (i.e. only a basic scheduler would be required). As will be apparent to one skilled in the art, two or more classes may be mapped to a single port for economy.
B) Using a single Ethernet port that supports multiple QoS. In this instance a packet may be mapped onto a single Ethernet port that implements one of various scheduling techniques for supporting multiple QoS. Such techniques include class-based queuing, weighted fair queuing, or hierarchical scheduling (for example the first level selects the overall service category, the second level selects the VLAN, and the third level schedules the queue based on the VLAN p-bits).

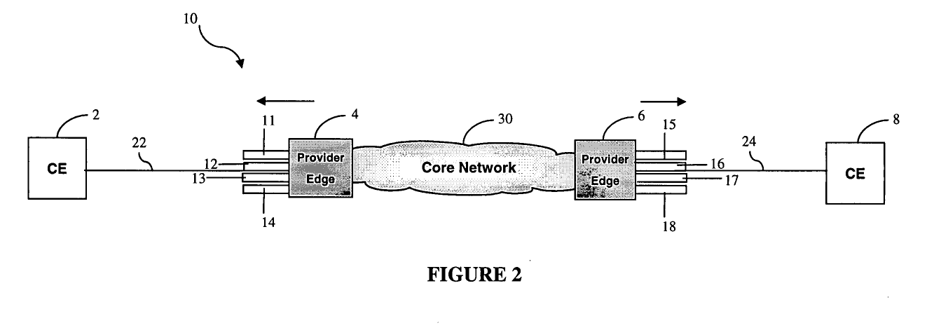

The QoS techniques described above for both the IWU to ATM and IWU to Ethernet directions may be combined in various ways, and used in various network and service interworking scenarios. FIGS. 2-5 illustrate three such examples.

FIG. 2 illustrates a schematic of an Ethernet/ATM communication system according to an embodiment of the present invention. The communication system 10 includes a first IWU 4, which includes four class queues 11, 12, 13, 14, which queues are in turn connected to a first access link 22. The first access link 22 is connected to a first customer equipment (CE) 2 using either an Ethernet port connection or an Ethernet VLAN connection. The communication system 10 further includes a second IWU 6, which includes four class queues 15, 16, 17, 18, which are each connected to a second access link 24. It should be understood that any number of class queues may be present and that the choice of 4 class queues is merely for purposes of illustration. Typically said class queues fall within the range of anywhere from 2 to 8. The second access link 24 is connected to a second CE 8 using a single ATM virtual circuit connection. The IWUs 4 and 6 are connected together over a network link through a network core 30. While the term “network link” is used herein, it should be understood that such network link is not limited to merely a trunk between the two IWU, but may include IWUs that are connected over some logical or physical connections spanning multiple networking nodes.

According to this embodiment of the invention, data packets may be transmitted from the first CE 2 to the second CE 8 or vice versa. As will be apparent to one skilled in the art, a data packet may include both variable size frames and fixed size cells, and may carry any type of information including computer communications traffic, voice or video.

The first CE 2 transmits Ethernet data packets to the IWU 4 over the first access link using the Ethernet protocol. The IWU 4 then forwards the data packets to the second IWU 6, which converts the Ethernet data packets to ATM data packets. The second edge device 6 then transmits the ATM data packets to the second CE 8.

It should be noted that the Ethernet data packets transmitted by the first CE 2 may be converted to ATM data packets at the first IWU 4, and then forwarded to the second IWU 6 using the ATM protocol, which in turn transmits the data packets to their destination, the CE 8. Alternatively, the Ethernet data packets transmitted by the first CE 2 may be forwarded through the core network using the Ethernet protocol, and then converted to ATM data packets at the second IWU 6. It should be further noted that the forwarding of data packets between the two IWUs 4 and 6 may be done using any other network protocol (including IP or MPLS) provided the packets are ultimately translated into either the Ethernet or ATM at the ingress side of the IWUs 4 or 6 depending on which edge device is interworking between the two protocols.

To enable a desired QoS level for each data packet transmitted between CE 2 and CE 8, the data packets can be classified with a QoS level based on the delay, delay variation, and bandwidth they require for transmission. To enable end-to-end QoS for data transmitted between CE 2 and CE 8, the first and second CE devices, the IWUs, and the core network, preferably provide preferential treatment for the higher-priority classes over the lower-priority ones.

Multiple applications cam travel between the same CE devices, and each application may require different QoS (i.e., differing loss, delay, jitter requirements) and be subject to a differing service level agreement (SLA). Accordingly, the growing interest in Ethernet-ATM service interworking supports categories such as Premium, Platinum, Gold, Silver, and Bronze applications or any similar delineation of categories. Such applications can be classified by TABLE 1 shown below.

TABLE 1

| Traffic Category | Application Example | Service Name |
|---|---|---|
| Network Control | Alarms and heartbeats | Platinum |
| | Routing table updates | Platinum |
| Interactive | IP Telephony | Platinum |
| | Inter-Human Communications | |
| | Video | Platinum |
| | Inter-Human Communications | |
| Responsive | Streaming audio/video | Gold |
| | Human-Host Communications | |
| | eBusiness (B2B, B2C) | Silver |
| | Transaction Processing | |
| Timely | Email | Bronze |
| | Store and Forward | |
| | FTP | Bronze |
| | Best Effort | |
| Background | Pointcast | Bronze |
| | Background/Standby | |

For purposes of illustration, the QoS levels are divided into four levels, each representing a different level of service and are named platinum, gold, silver, and bronze but they may vary in the number, naming, and service characteristics. Data packets that require low loss, low jitter, and low delay are designated as a platinum service. These are data packets that typically require absolute priority and hence are supported by a single guaranteed bit rate. A second level of service is known as gold that specifies a minimum bandwidth guarantee and an upper delay bound, and is supported by two rates for guaranteed and excess traffic. A third level is known as silver is used for transmitting packets that require a minimum bandwidth guarantee but no delay bounds. A fourth level is designated as bronze and is used for best effort service for which the loss, delay, and jitter are typically not specified.

Again, referring to FIG. 2, data packets transmitted by the first CE 2 are received by the first IWU 4. These packets are routed over the network to the second IWU 6. The second IWU 6 reads the header portion of each Ethernet frame, which includes the source address, the destination address and an IEEE 802.1Q tag. The 802.1Q tag may include a VLAN-ID and a three-bit priority indication, commonly known as the p-bits. The p-bits can encode a combination of class of service and drop precedence. Accordingly the IWU 6 is operate to, among other things, perform the following functions:
using the p-bits, VLAN ID, or both VLAN and p-bits carrying the QoS information to select the class of service queue to which the data packet is forwarded;
using the p-bits carrying the drop precedence information to assign a drop precedence to each packet within each class queue;
using a weighted fair queue (or a class-based queuing) scheduler to send data packets from the class of service queues on the access link to CE 8 in the order determined by the class of service precedence rules;
dropping data packets according to the drop precedence in each class of service queue when the access link is congested;
transmitting the data packet over a single ATM VCC. The scheduler in this case must transmit complete frames from each queue, and not allow interleaving of cells from frames transmitted by the different queues. Frame boundaries for data frames spanning multiple cells are commonly recognized by detecting the special encoding of the last cell of each AAL 5 (ATM Adaptation Layer 5) frame. This capability is essential for the correct separation and reassembly of frames at the receiving end. It should be noted that this value-added capability is beyond the Standard ATM protocol specifications and the capabilities of most legacy ATM switches (these switches typically interleave cells from multiple queues, and rely on the VC identifier for separating the frames).
   For purposes of this specification, the foregoing technique is known as Ethernet-aware ATM.

In the reverse direction, the data packets are received by the second IWU 6 from CE 8, which transmits them over the network to the first IWU 4. The IWU 4 reads the header portion of each Ethernet frame (it is assumed for example that the native service between the CEs is Ethernet), which includes the source address, the destination address, and the mapping of part of the IEEE 802.1 Q tag, namely the VLAN-ID and/or the p-bits. The p-bits encode a combination of class of service and drop precedence. The IWU 4 performs the following functions:
using the p-bits, VLAN-ID, or both VLAN and p-bits to determine the QoS information that are used to select the class of service queue to which the data packet is forwarded;
using the Ethernet p-bits carrying the drop precedence information or the ATM CLP bit to assign a drop precedence to each packet within each class queue;
using a weighted fair queue scheduler (or a class-based queuing scheduler) to send data packets from the class of service queues on the access link to CE 2 in the order determined by the class of service priority rules;
dropping data packets according to the drop precedence in each class of service queue when the access link is congested;
transmitting the data packet over the Ethernet interface.

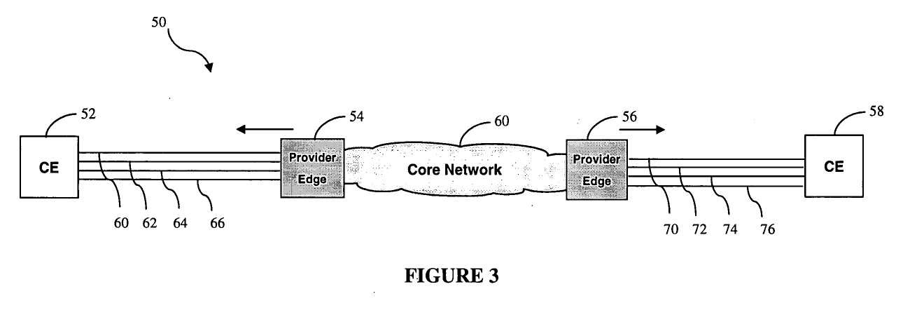

FIG. 3 illustrates a schematic of an Ethernet/ATM communication system 50 according to a second embodiment of the present invention. The communication system 50 includes a first CE 52 connected to first IWU 54 with multiple Ethernet port connections (60, 62, 64, 66). The communication system 50 further includes a second CE 58 connected to a second IWU 56 with multiple virtual circuit connections (70, 72, 74, 76). The IWUs 54, 56 are also connected together over a network link (not shown) through a core network 61.

In this embodiment of the invention, the data packets transmitted across the network from the first CE 52 to the second CE 58 are each classified with a QoS level as described above. Ethernet data packets are transmitted from the first CE 52 to the first IWU 54 over the multiple Ethernet port connections, with each port connection transmitting data packets designated with a specific QoS level. For example, the Ethernet port 60 may be used to transmit platinum level data packets, the Ethernet port 62 may be used to transmit gold level data packets, the Ethernet port 64 may be used to transmit silver level data packets and the Ethernet port 66 may be used to transmit bronze level. The data packets received by the first IWU 54 are routed over the core network 61 to the second IWU 56.

In FIG. 3, the second IWU 56 is connected to the second CE 58 with multiple VCC's 70, 72, 74, 76. Each VCC, 70, 72, 74, 76, carries data traffic corresponding to a particular QoS. For example, VCC 70 may be used to carry constant bit rate CBR traffic, VCC 72 may be used to carry real-time variable bit rate (rt-VBR) traffic, VCC 74 may be used to carry non-real-time variable bit rate (nrt-VBR) traffic, and VCC 76 may be used to carry UBR traffic.

The Ethernet data packets received at the second IWU 56 are each mapped to an ATM VCC based on the port number from which the data packet was transmitted. For example, if a data packet is received from the Ethernet port 60, which may be supporting a platinum level QoS, then the data packet is mapped to the ATM VCC 70. If a data packet is received from the Ethernet port 62, then the data packet is mapped to ATM VCC 72. If a data packet is received from the Ethernet port 64, then the data packet is mapped to ATM VCC 74. If a data packet is received from the Ethernet port 66, then the data packet is mapped to ATM VCC 76. Once the data packets have been mapped to the appropriate ATM VCC, a scheduler schedules the transmission of the data packets to the CE 58.

It should be noted that in a further embodiment of the invention, the CE 52 may be connected to the first IWU 54 using multiple VLAN's. In this embodiment, the second CE 56 reads the header portion of the Ethernet data packet, which includes the source address, the destination address and an IEEE 802.1Q tag. The IEEE 802.1Q tag includes a 12-bit tag, which identifies the VLAN that transmitted the data packet. Based on this VLAN ID, the data packet is mapped to a queue for an ATM VCC that carries data of a particular class of service that corresponds to the class of service of the VLAN that transmitted the data packet. For example, if the VLAN ID was associated with platinum service data packets, the data packet may be mapped to an ATM VCC with a CBR.

In FIG. 3, ATM data packets may also be transmitted from the second CE 58 to the first CE 52. Each VCC is designated an ATM QoS level. For example, the ATM data packets are received by the first IWU 54 and mapped to a queue that is connected to a particular Ethernet port or queue, depending from which VCC the data packet was received. For example, if the VCC is configured as a CBR VCC, then the ATM data packet is mapped to a platinum class service port or queue.

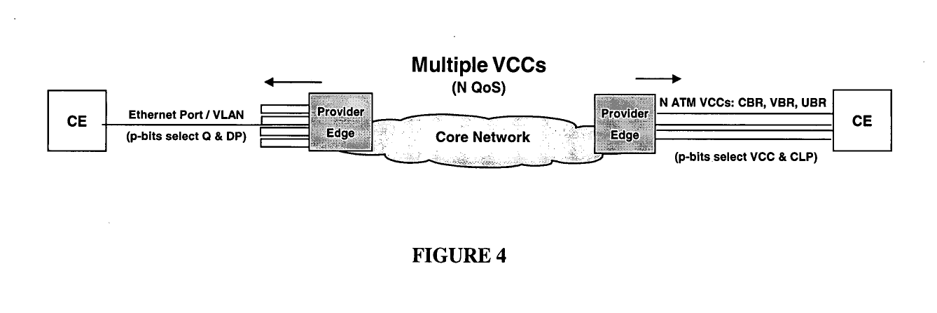

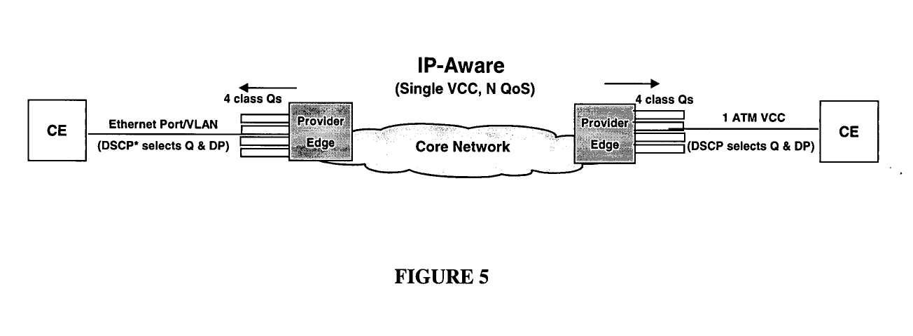

FIGS. 4 and 5 illustrate variations of the embodiments described above. Such variations may exist depending upon the given application requirements and desired QoS levels.

In particular, FIG. 4 is a schematic of a third embodiment of the present invention including a single Ethernet interface and multiple ATM VCCs where multiple QoS levels are provided. In such an embodiment, the ATM side uses one VCC for each QoS level (CBR, CBR, UBR) and the Ethernet side uses one interface (in VLAN-unaware mode) or one VLAN for all QoS levels. The p-bits are used for determining QoS. This configuration results in segregation of each QoS stream on the ATM side for interoperability with legacy ATM equipment, while using a single port or VLAN on the Ethernet side for efficiency and scalability.

FIG. 5 is a schematic of a fourth embodiment of the present invention including a single Ethernet interface (or VLAN) and a single ATM VCC where multiple QoS levels are provided. In such an embodiment, one VCC with Diff-Serv DSCP (or any other L3-L7 protocol, which may also include policy attributes, e.g., subscriber-ID) selects QoS on the ATM side while one Ethernet interface or one VLAN with Diff-Serv DSCP (or any other L3-L7 protocol together with policy attributes) selects QoS on the Ethernet side. This configuration results in operational simplicity, scalability, and dynamic bandwidth sharing and can work with either Ethernet interfaces operating in VLAN-unaware or VLAN-aware mode. However, this configuration is not a pure L2 service, but depends on L3 or higher layer protocol and may not be suitable for non-IP traffic thereby requiring modern IP-Aware Ethernet and ATM switches. The FIG. 5 configuration is similar to that of FIG. 2, except that Upper Layer Protocol (ULP) information (such as IP DiffServ, IP addresses, protocol type, TCP/UDP port numbers, and application layer information) are used individually or in combination instead of the Ethernet information for determining the service flows and their QoS. In this scenario, DSCP information may be used for assigning a packet drop precedence in either of the interworking directions. It should be noted that the IP-Aware term assumes that the layer 3 protocol is IP.

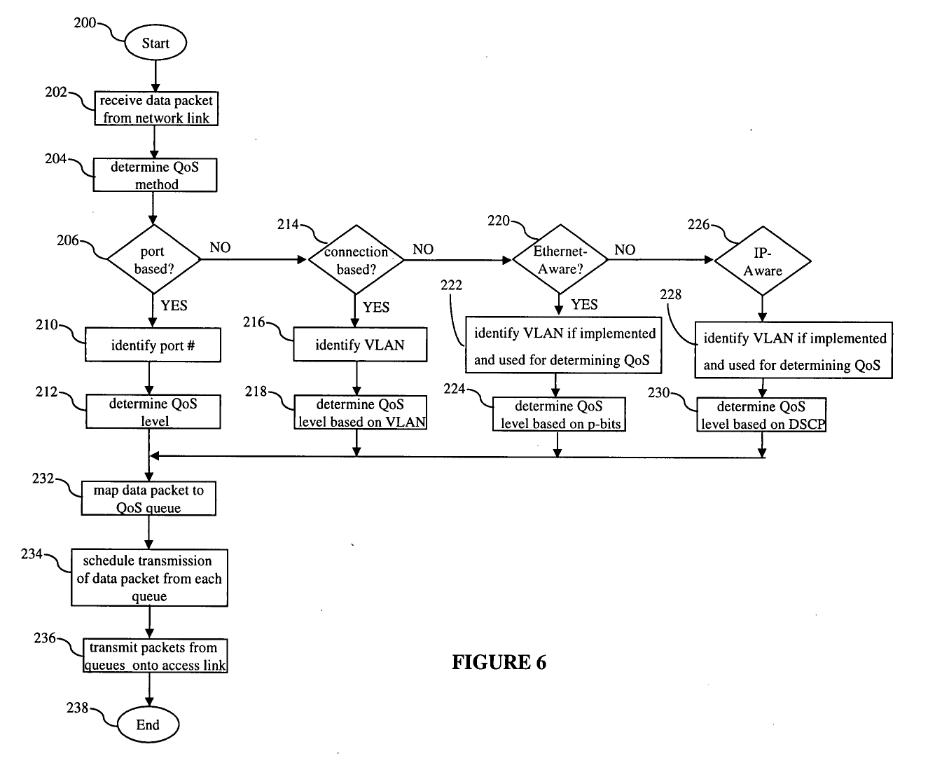

FIG. 6 shows a flowchart that details a process executed by IWU 6 to support multiple QoS for data packets transmitted from an IWU 6 to customer equipment CE as described in FIGS. 2-5. The process begins at step 200. In the next step 202, IWU 6 receives a data packet from a network link. The process proceeds to step 204 where the QoS method is determined based on the network QoS option to be used. Alternatively, it should of course be understood that the QoS method determination may not be a required if only one QoS determination method is used. Decisions 206, 214, 220, and 226 are used to respectively decide whether the QoS method used is port based, connection based, Ethernet-Aware, or IP-Aware.

If the QoS method determined is “port based”, then the process proceeds to step 210. In step 210, the process identifies the port identifier from which the data packet was received. The process then proceeds to step 212, where it determines the QoS level of the data packet based on the port identifier the data was transmitted by the CE 2. Once the QoS level is determined in step 212, the process proceeds to step 232 described below.

If the QoS service method determined is “connection based”, then the process proceeds to step 216. In step 216, the process identifies the VLAN that the CE 2 transmitted the data packet to the IWU 6. The process then proceeds to step 218, where it determines the QoS level of the data packet based on the VLAN identifier determined in step 216. Once the QoS level is determined in step 218, the process proceeds to step 232 described below.

If the QoS service method determined is “Ethernet-Aware”, then the process proceeds to step 222. In step 222, the process may identify the VLAN the CE 2 transmitted in the data packet to the IWU 6. The process then proceeds to step 224, where it determines the QoS level of the data packet based on the VLAN identifier (if applicable) determined in step 222 and the p-bits of the Ethernet header. Note that the QoS of VLAN-aware Ethernet IWUs can be determined based on a combination of VLAN and p-bits, or p-bits only, depending on whether VLAN identifiers are used for QoS.

Once the QoS level is determined in step 224, the process proceeds to step 232 described below.

If the QoS service method determined is “IP-Aware”, then the process proceeds to step 228. In step 228 it may identify the VLAN the CE 2 transmitted the data packet from. The process then proceeds to step 230, where it determines the QoS level of the data packet based on the VLAN identifier (if applicable) determined in step 228 and the DSCP bits of the IP header in the Ethernet frame. Once the QoS level is determined in step 230, the process proceeds to step 232 as described below. Note again, QoS of VLAN-aware Ethernet IWUs can be determined based on a combination of VLAN and DSCP, or DSCP information only, depending on whether VLAN identifiers are used for connection identification.

Upon determining whether the QoS method is port-based, connection-based, Ethernet-aware, or IP-Aware, along with determining the related parameters, the method continues with step 232. In step 232, the process maps the data packet to an ATM VCC and corresponding service queue that corresponds to the QoS level previously determined. The process then proceeds to step 234 where the transmission of the data packets stored in the service queues are scheduled. The process then proceeds to step 236, where data packets from the service queues are transmitted onto the access link. The process ends at step 238.

As will be apparent to one skilled in the art the process set out in FIG. 6 could be modified to for purposes of processes executed by the IWU 4 for transmitting frames in the IWU-to-CE2 direction by taking into consideration ATM VCC information at the identifying stage and then mapping the data packet to a corresponding service queue on the Ethernet interface.

As will be further apparent to one of skill in the art, the techniques described above can be implemented in digital electronic circuitry, in computer hardware, firmware, software, or in combinations thereof.

It should be understood that the preferred embodiments mentioned here are merely illustrative of the present invention. Numerous variations in design and use of the present invention may be contemplated in view of the following claims without straying from the intended scope and field of the invention herein disclosed.

1. A method for enabling multiple QoS support over Asynchronous Transfer Mode (ATM) and Ethernet networks comprising:
Identifying a packet according to a first network protocol for servicing;
Determining a QoS metric for the identified packet; and
Based upon the determined QoS metric, servicing the identified packet for transmission in accordance with a second network protocol.

2. A method as claimed in claim 1 wherein the step of determining a QoS metric includes considering Ethernet information.

3. A method as claimed in claim 2 wherein the Ethernet information includes Ethernet port information.

4. A method as claimed in claim 2 wherein the Ethernet information includes virtual local area network identifier (VLAN ID) information.

5. A method as claimed in claim 2 wherein the Ethernet information includes p-bits information.

6. A method as claimed in claim 5 wherein the Ethernet information further includes VLAN ID information.

7. A method as claimed in claim 5 wherein the step of servicing further includes assigning a drop precedence to the packet based on the p-bits information.

8. A method as claimed in claim 1 wherein the step of determining a QoS metric includes considering Upper Layer Protocol (ULP) information.

9. A method as claimed in claim 8 wherein the ULP information includes Internet Protocol (IP) packet information

10. A method as claimed in claim 9 wherein the IP packet information includes Differentiated Services Code Point (DSCP) bit information.

11. A method as claimed in claim 10 wherein the IP packet information further includes VLAN ID information.

12. A method as claimed in claim 10 wherein the step of servicing further includes assigning a drop precedence to the packet the based on the DSCP bit information.

13. A method as claimed in claim 1 wherein the first network protocol is ATM, the second network protocol is Ethernet, and the step of determining a QoS metric includes considering ATM information.

14. A method as claimed in claim 13 wherein the ATM information includes virtual circuit connection information.

15. A method as claimed in claim 13 wherein the step of servicing further includes assigning a drop precedence to the packet based on cell loss priority bit information.

16. A method as claimed in claim 1 wherein the first network protocol is Ethernet and the second network protocol is ATM and the step of servicing includes mapping the packet to a VCC and scheduling the packet for transmission according to a non-interleaving sub-connection scheduling scheme.

17. A method as claimed in claim 1 wherein the first network protocol is Ethernet and the second network protocol is ATM and the step of servicing includes mapping the packet to one of a plurality of VCC's and scheduling the packet for transmission according to a connection scheduling scheme.

18. A method as claimed in claim 1 wherein the first network protocol is Ethernet and the second network protocol is ATM and the step of servicing includes mapping the packet to a virtual path (VP) and scheduling the packet for transmission according to a sub-connection scheduling scheme.

19. A method as claimed in claim 1 wherein the first network protocol is ATM and the second network protocol is Ethernet and the step of servicing includes mapping the packet to an Ethernet port and scheduling the packet for transmission according to a class scheduling scheme.

20. A method as claimed in claim 1 wherein the first network protocol is ATM and the second network protocol is Ethernet and the step of servicing includes mapping the packet to one of a plurality of Ethernet ports and scheduling the packet for transmission according to a basic scheduling scheme.

21. A system for enabling multiple QoS support over ATM and Ethernet networks comprising:
an input; and
control circuitry associated with the input and adapted to:
identify a packet according to a first network protocol for servicing;
determine a QoS metric for the identified packet; and
based upon the determined QoS metric, service the identified packet for transmission in accordance with a second network protocol.

22. A system as claimed in claim 21 wherein the control circuitry is further adapted to consider Ethernet information to determine a QoS metric.

23. A system as claimed in claim 22 wherein the Ethernet information further includes Ethernet port number information.

24. A system as claimed in claim 22 wherein the Ethernet information further includes VLAN ID information.

25. A system as claimed in claim 22 wherein the Ethernet information further includes p-bits information.

26. A system as claimed in claim 25 wherein the Ethernet information further includes VLAN ID information.

27. A system as claimed in claim 25 wherein the control circuitry is further adapted to assign a drop precedence to the packet based on the p-bits information.

28. A system as claimed in claim 21 wherein the control circuitry is further adapted to consider Upper Layer Protocol (ULP) information to determine a QoS metric.

29. A system as claimed in claim 28 wherein the ULP information includes Internet Protocol (IP) information.

30. A system as claimed in claim 29 wherein the IP information includes Diff-Serv Differentiated Services Code Point (DSCP) bit information.

31. A system as claimed in claim 30 wherein IP information further includes virtual local network identifier (VLAN ID) information.

32. A system as claimed in claim 30 wherein the control circuitry is further adapted to assign a drop precedence to the packet based on the DSCP bit information.

33. A system as claimed in claim 21 wherein the first network protocol is ATM, the second network protocol is Ethernet, and wherein the control circuitry is further adapted to consider ATM information to determine a QoS metric.

34. A system as claimed in claim 33 wherein ATM information includes virtual circuit connection information.

35. A system as claimed in claim 33 wherein the control circuitry is further adapted to assign a drop precedence based on CLP bit information.

36. A system as claimed in claim 21 wherein the first network protocol is Ethernet and the second network protocol is ATM and the control circuitry is further adapted to map the packet to a VCC and schedule the packet for transmission according to a non-interleaving sub-connection scheduling scheme to service the packet.

37. A system as claimed in claim 21 wherein the first network protocol is Ethernet and the second network protocol is ATM and the control circuitry is further adapted to map the packet to one of a plurality of VCC's and schedule the packet for transmission according to a connection scheduling scheme to service the packet.

38. A system as claimed in claim 21 wherein the first network protocol is Ethernet and the second network protocol is ATM and the control circuitry is further adapted to map the packet to a virtual path (VP) and schedule the packet for transmission according to a sub-connection scheduling scheme to service the packet.

39. A system as claimed in claim 21 wherein the first network protocol is ATM and the second network protocol is Ethernet and the control circuitry is further adapted to map the packet to an Ethernet port and schedule the packet for transmission according to a class scheduling scheme to service the packet.

40. A method as claimed in claim 21 wherein the first network protocol is ATM and the second network protocol is Ethernet and the control circuitry is further adapted to map the packet to one of a plurality of Ethernet ports and schedule the packet for transmission according to a basic scheduling scheme to service the packet.

41. A system as claimed in claim 21 wherein the system is located at an edge of a core network.

42. A system as claimed in claim 21 wherein the system is located in a user element.
